(19) United States
(12) Patent Application Publication
(10) Pub. No.: US 2015/0117051 A1
(43) Pub. Date: Apr. 30, 2015

(54) DISPLAY DEVICE AND BACKLIGHT MODULE

(71) Applicant: Wistron Corporation, New Taipei City (TW)

(72) Inventor: Yi-Hsin Lin, New Taipei City (TW)

(73) Assignee: Wistron Corporation, New Taipei City (TW)

(21) Appl. No.: 14/224,084

(22) Filed: Mar. 25, 2014

(30) Foreign Application Priority Data
Oct. 30, 2013 (CN) 201320676916.X

(51) Int. Cl. F21V 8/00

(52) U.S. Cl. CPC G02B 6/0091
USPC 362/606; 362/613

(57) ABSTRACT

A backlight module includes a bottom frame, a light guide plate, a lighting bar and a supporting bar. The light guide plate is disposed on the bottom plate of the bottom frame. The lighting elements are arranged in a row on a setting surface of the flexible circuit board of the lighting bar. Two parts of the setting surface at two sides of the row of lighting elements are a first region and a second region, respectively. The bottom of the supporting bar is attached to the bottom plate. The top of the supporting bar is attached to the first region. A portion of the light emitting surface of the light guide plate adjacent to the light incident side-surface of the light guide plate is attached to the second region. The lighting elements are between the supporting bar and the light incident side-surface.

### CROSS-REFERENCE TO RELATED APPLICATION

This application claims the priority benefit of China application serial no. 201320676916.X, filed on Oct. 30, 2013. The entirety of the above-mentioned patent application is hereby incorporated by reference herein and made a part of this specification.

### BACKGROUND OF THE INVENTION

1. Field of the Invention

The present application generally relates to a display device and a backlight module, and in particular, to the display device and the backlight module using the lighting bar.

2. Description of Related Art

The current electronic device is mostly configured with the display module to provide the best human machine interface. However, display panel itself of some display module can not emit light, thus it need to be configured with a backlight module under the display panel to provide the light necessary for displaying. The conventional backlight module includes a light source and a light guide plate, the light emitted by the light source enters one side of the light guide plate and is emitted from the light emitting surface of the light guide plate and enters the display panel.

FIG. 1 is a sectional view diagram illustrating the partial of the conventional backlight module. Referring to FIG. 1, when assembling the conventional backlight module 110, first, the light guide plate 110 and the plastic frame 120 surrounding the light guide plate 110 are assembled in the bottom frame 130. Next, the lighting bar 140 is attached on the plastic frame 120, and makes the light elements 142 on the lighting bar 140 be located between the plastic frame 120 and the light incident side 112 of the light guide plate 110. However, since the light elements 142 face downwards while the lighting bar 140 is attached, it is hard to ensure whether the distance between the light elements 142 and the light incident side 112 is maintained at the ideal value or not. The distance between the lighting elements 142 and the light incident side 112 may effect whether the distribution of the brightness of the light emitted from the light emitting surface of the light guide plate 110 is uniform or not. In other words, the design of the conventional backlight module 100 may result in the optical characteristics of the backlight module is unable to be effectively controlled in the ideal status.

### SUMMARY

The present application provides a backlight module which may solve the problem that the optical characteristics of the backlight module is unable to be effectively controlled.

The present application provides a display device which may solve the problem that the optical characteristics of the backlight module using in the display module is unable to be effectively controlled.

The backlight module of the present application includes a bottom frame, a light guide plate, a lighting bar and a supporting bar. The light guide plate is disposed on the bottom plate and includes a bottom surface, a light emitting surface, and a light incident side-surface. The bottom surface is opposite to the light emitting surface. The light incident side-surface is connected to the bottom surface and the light emitting surface. The lighting bar includes a flexible circuit board and a plurality of lighting elements. The lighting elements are arranged in a row on a setting surface of the flexible circuit board. The setting surface has a first region and a second region located at two sides of the row of lighting elements. The supporting bar includes a bottom and a top opposite to the bottom. The bottom is attached to the bottom plate. The top is attached to the first region of the setting surface. A portion of the light emitting surface adjacent to the light incident side-surface is attached to the second region of the setting surface. The lighting elements are between the supporting bar and the light incident side-surface.

The display device of the present application includes a display panel and a backlight module. The display panel is disposed on the backlight module. The backlight module includes a bottom frame, a light guide plate, a lighting bar and a supporting bar. The light guide plate is disposed on the bottom plate and includes a bottom surface, a light emitting surface, and a light incident side-surface. The bottom surface is opposite to the light emitting surface. The light incident side-surface is connected to the bottom surface and the light emitting surface. The light guide plate is disposed between the bottom plate and the display panel. The lighting bar includes a flexible circuit board and a plurality of lighting elements. The lighting elements are arranged in a row on a setting surface of the flexible circuit board. The setting surface has a first region and a second region located at two sides of the row of lighting elements. The supporting bar includes a bottom and a top opposite to the bottom. The bottom is attached to the bottom plate. The top is attached to the first region of the setting surface. A portion of the light emitting surface adjacent to the light incident side-surface is attached to the second region of the setting surface. The lighting elements are between the supporting bar and the light incident side-surface.

In an embodiment of the present application, a distance between the bottom and the top of the supporting bar is substantially equal to a thickness of the light guide plate.

In an embodiment of the present application, the top and the first region of the setting surface are attached to each other partially.

In an embodiment of the present application, the backlight module further includes a reflector disposed between the light guide plate and the bottom plate.

In an embodiment of the present application, a distance between the bottom and the top of the supporting bar is substantially equal to a total thickness of the light guide plate and the reflector.

In an embodiment of the present application, the bottom frame further includes a side plate, connected to an edge of the bottom plate, the side plate is bent outward to form a support piece, and the support piece is attached to the first region of the setting surface.

In an embodiment of the present application, the backlight module further includes a double-sided adhesive, wherein the support piece is attached to the first region of the setting surface through the double-sided adhesive.

In an embodiment of the present application, the surface of the support piece includes an aligning line, the edge of the flexible circuit board is aligned with the aligning line.

In an embodiment of the present application, the backlight module further includes a plastic frame disposed on the bottom plate. The plastic frame and the supporting bar surround the light guide plate together. The plastic frame makes the light guide plate be attached on the bottom plate.

In an embodiment of the present application, the display device further includes a strip pad, disposed between the flexible circuit board and the display panel.

Based on the above, in the display device and the backlight module of the present application, the lighting bar is attached to the light guide plate, the distance between the lighting elements and the light incident side-surface can be precisely controlled, thus ensuring that the optical characteristics of the backlight module is in an ideal state, and thereby allowing the display device to have a better display quality.

In order to make the aforementioned and other features and advantages of the present application more comprehensible, several embodiments accompanied with figures are described in detail below.

### BRIEF DESCRIPTION OF THE DRAWINGS

FIG. 1 is a sectional view diagram illustrating the partial of the conventional backlight module.

FIG. 2 is a partial sectional view diagram illustrating a display device according to an embodiment of the present application.

FIG. 3 is a partial sectional view diagram illustrating one side of the display device away from the lighting bar depicted in FIG. 2.

FIG. 4 is an exploded view diagram illustrating the backlight module depicted in FIG. 2.

FIG. 5 is a partial sectional view diagram illustrating a backlight module according to another embodiment of the present application.

### DESCRIPTION OF THE EMBODIMENTS

FIG. 2 is a partial sectional view diagram illustrating a display device according to an embodiment of the present application. Referring to FIG. 2, the display device 50 of the present embodiment includes a display panel 52 and a backlight module 200. The display panel 52 is disposed on the backlight module 200. The backlight module 200 in an embodiment of the present application includes a bottom frame 210, a light guide plate 220, a lighting bar 230 and a supporting bar 240. The bottom frame 210 comprises a bottom plate 212. The light guide plate 220 is disposed on the bottom plate 212 and includes a bottom surface 222, a light emitting surface 224, and a light incident side-surface 226. The bottom surface 222 is opposite to the light emitting surface 224. The light incident side-surface 226 is connected to the bottom surface 222 and the light emitting surface 224. The present embodiment takes the bottom plate 222 parallel with the light emitting surface 224 and perpendicular to the light incident side-surface for the example, but the present application is not limited thereto. The light guide plate 220 is located between the bottom plate 212 and the display panel 52. The lighting bar 230 includes a flexible circuit board 232 and a plurality of lighting elements 234. The lighting elements 234 are arranged in a row on a setting surface 232A of the flexible circuit board 232. The lighting elements 234 arranged in a row means that the lighting elements 234 are arranged along a direction regularly, and these lighting elements 234 can be arranged in a single row or multiple rows. The setting surface 232A located at one side (for example, the left side of FIG. 2) of the row (single row or multiple rows) of lighting elements 234 is a first region 232A1, and the setting surface 232A located at another side (for example, the right side of FIG. 2) of the row (single row or multiple rows) of lighting elements 234 is a second region 232A2. The supporting bar 240 includes a bottom 242 and a top 244 opposite to the bottom 242. The bottom 242 is attached to the bottom plate 212. The top 244 is attached to the first region 232A1 of the setting surface 232A. The “attachment” referred to herein takes “adhesion” for the example, but is not limited thereto. A portion of the light emitting surface 224 adjacent to the light incident side-surface 226 is attached to the second region 232A2 of the setting surface 232A. The lighting elements 234 are between the supporting bar 240 and the light incident side-surface 226.

From the above, the flexible circuit board 232 of the lighting bar 230 is attached beside the light incident side-surface 226 of the light guide plate 220, therefore the distance between the lighting elements 234 of the lighting bar 230 and light incident side-surface 226 of the light guide plate 220 may be precisely controlled. Such that, the light provided by the lighting elements 234 may enter from the light incident side-surface 226 into the light guide plate 220 according to the optical path of the original design, and exit from the light emitting surface 224 of the light guide plate 220 into the display panel 52. Due to the distance between the lighting elements 234 and the light incident side-surface 226 is precisely controlled in a ideal value, and the light emitted from the light emitting surface 224 has a uniform luminance distribution, so that the display device 50 has a better display quality.

In the present embodiment, the backlight module 200 further includes a reflector 250 disposed between the light guide plate 220 and the bottom plate 212. The reflector 250 may reflect the light emitted from the bottom 222 of the light guide plate 220 back to the light guide plate 220 for increasing the light utilization efficiency of the backlight module 200. The distance between the bottom 242 and the top 244 of the supporting bar 240 is substantially equal to a total thickness of the light guide plate 220 and the reflector 250 in the present embodiment. Herein, “substantially equal” means that they are equal after eliminating the common variable such as the tolerances of manufacturing and the like. With this design, the top 244 of the supporting bar 240 and the light emitting surface 224 of the light guide plate 220 are at the same height for providing two coplanar support surfaces of the flexible circuit board 232 of the lighting bar 230. In an un-illustrated embodiment, if there is no reflector, the distance between the bottom 242 and the top 244 of the supporting bar 240 is substantially equal to the thickness of the light guide plate 220, and may also provide two coplanar support surfaces of the flexible circuit board 232 of the lighting bar 230.

In the present embodiment, the top 244 of the supporting bar 240 and the first region 232A1 of the setting surface 232A of the flexible circuit board 232 are attached to each other partially. That is, whether adhesive force is provided from the double-sided adhesive or any other means, the top 244 of the supporting bar 240 and the setting surface 232A of the flexible circuit board 232 do not need to be attached to each other continuously, but may attached to each other partially, such that may reduce the difficulty of rework or repair. Certainly, the top 244 of the supporting bar 240 and the first area 232A1 of the setting surface 232A of the flexible circuit board 232 may also be continuously attached to each other from beginning to end. Furthermore, the portion of the light incident side-surface 226 adjacent to the light emitting surface 224 may also be attached to the second area 232A2 of the setting surface 232A by using the double-sided adhesive or any other means which provide adhesive force.

The backlight module 200 of the present embodiment may further includes a plurality of optical films 270 disposed on the light emitting surface 224 of the light guide plate 220 for further enhancing the optical characteristics of the backlight module 200. The backlight module of the present embodiment may also include a strip pad 280 disposed between the flexible circuit board 232 and the display panel 52. The strip pad 280 may isolate the display panel 52 from the lighting bar 230 to avoid damage of the display panel 52 caused by the light emitting elements 234 in high-temperature and too close to the display panel 52 during the working state.

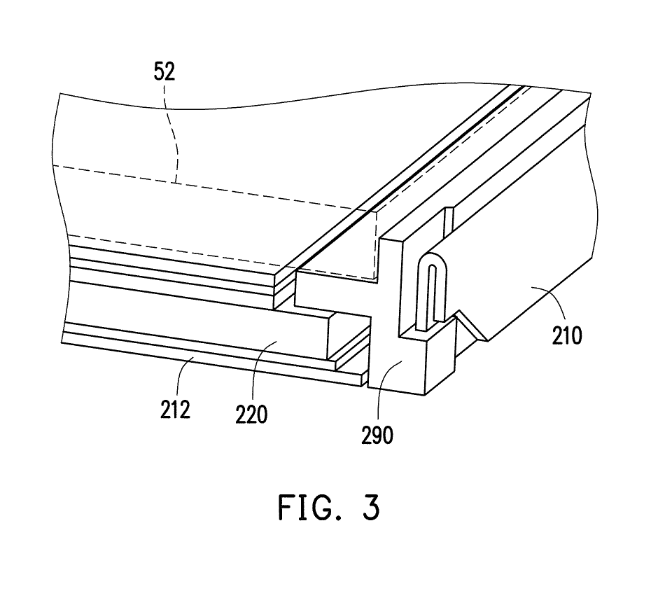

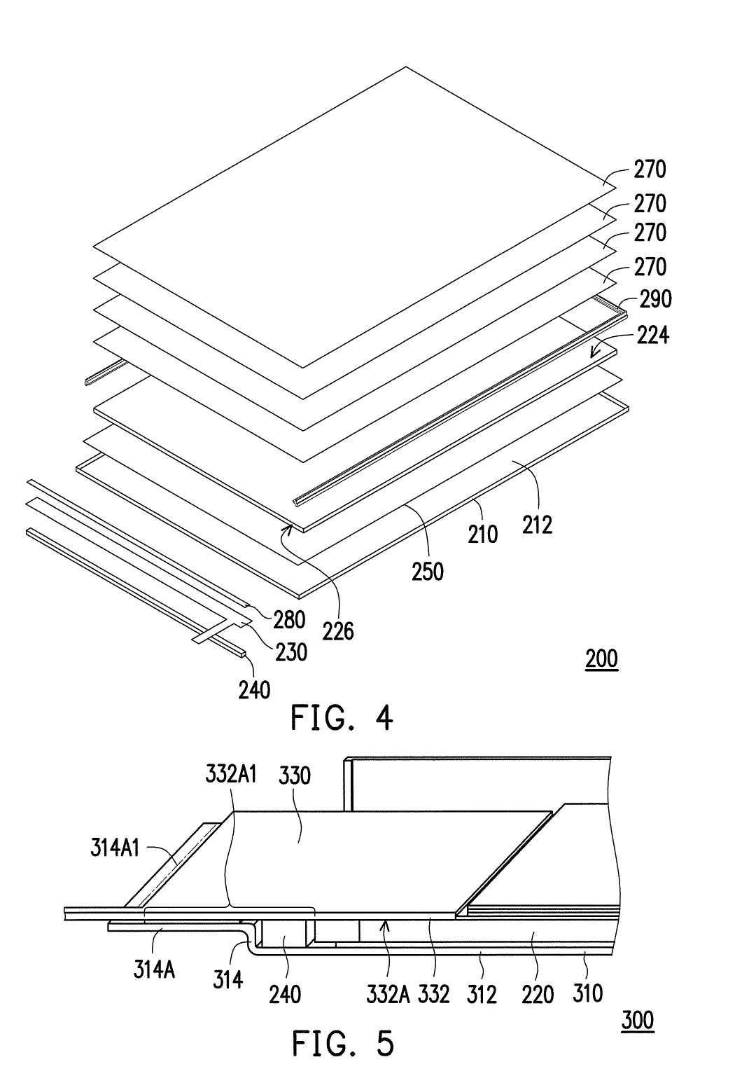

FIG. 3 is a partial sectional view diagram illustrating one side of the display device away from the lighting bar depicted in FIG. 2, and FIG. 4 is an exploded view diagram illustrating the backlight module depicted in FIG. 2. Referring to FIG. 3 and FIG. 4, the backlight module 200 of the present embodiment may also include a plastic frame 290 disposed on the bottom plate 212. The plastic frame 290 and the supporting bar 240 surround the light guide plate 220 together. The plastic frame 290 makes the light guide plate 220 be attached on the bottom plate 212, and the plastic frame 290 may wedged with the bottom frame 210. The plastic frame 290 and the strip pad 280 support the display panel 52 together.

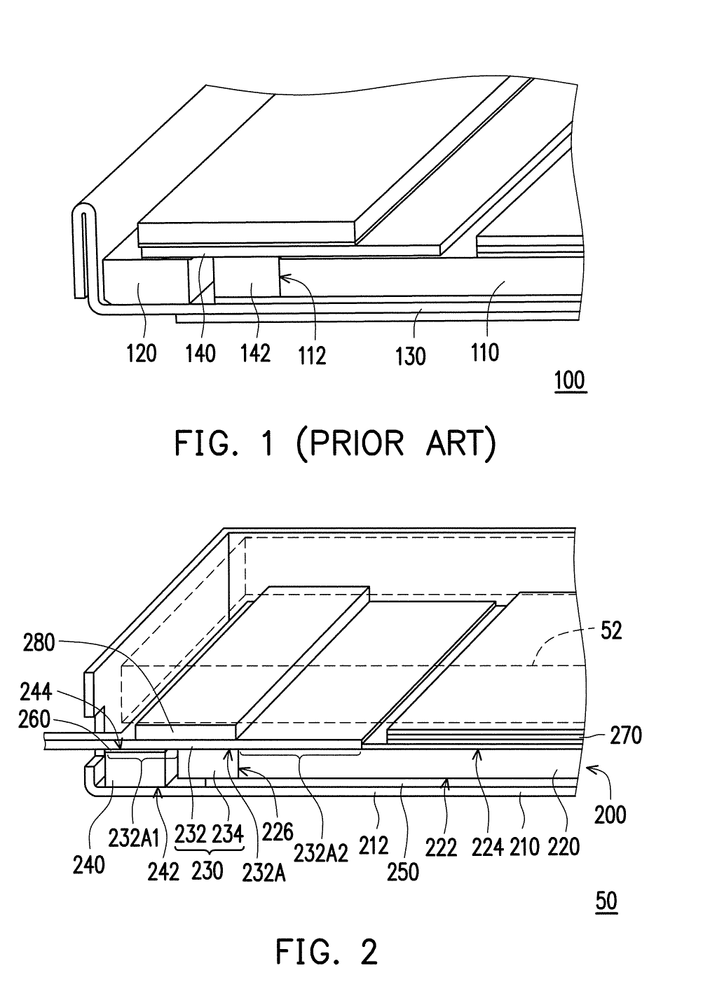

Next, the assembly method of the backlight module of the present embodiment is illustrated with referring to FIG. 2 and FIG. 4. When assembling the backlight module 200 of the present embodiment, first, the reflector 250 is put on the bottom plate 212 of the bottom frame 210. Furthermore, the flexible circuit board 232 of the lighting bar 230 is attached to the portion of the light emitting surface 224 of the light guide plate 220 adjacent to the light incident side-surface 226. When assembling the lighting bar 230 and the light guide plate 220, the lighting bar 230 and the light guide plate 220 can be turned over, so as to directly observe and adjust the distance between the lighting elements 234 of the lighting bar 230 and the light incident side-surface 226 of the light guide plate 220. On the contrary, when assembling the conventional backlight module 100 of the FIG. 1, since the light guide plate 110 and the plastic frame 120 both have been assembled in the bottom frame 130, the light guide plate 110 and the lighting bar 140 can not be turned over, and the distance between the lighting elements 142 and the light incident side 112 can not be directly observed and accurately controlled. Furthermore, the strip pad 280 and the supporting bar 240 can be attached to the lighting bar 230.

Then, continuing to refer to FIG. 4, the light guide plate 220, the lighting bar 230, the strip pad 280 and the supporting bar 240 which have been attached to each other are disposed on the bottom plate 212 together, wherein the light guide plate 220 is located on the reflector 250. And then, the plastic frame 290 is disposed in the bottom frame 210, and the plastic frame 290 makes the light guide plate 220 be attached on the bottom plate 212. Furthermore, the optical films 270 are also disposed on the light emitting surface 224 of the light guide plate 220. At this point, the assembling of the backlight module 200 of the present embodiment is almost completed. From the above, the lighting bar 230 can be assembled with the light guide plate 220 before the light guide plate 220 is disposed in the bottom frame 210 by changing the design of the plastic frame 290 or directly cancelling the use of the plastic frame 290, so as to ensure that the backlight module 200 has better optical characteristics.

FIG. 5 is a partial sectional view diagram illustrating a backlight module according to another embodiment of the present application. Referring to FIG. 5, the backlight module 300 of the present embodiment is similar to the backlight module 200 of FIG. 2, the difference is that the bottom frame 310 of the present embodiment has a bottom plate 312 and a side plate 314, and the side plate 314 is bent outward to form a support piece 314A. The side plate 314 is connected to the edge of the bottom plate 312. The support piece 314A is attached to the first area 332A1 of the setting surface 332A of the flexible circuit board 332 of the lighting bar 330. In other words, the lighting bar 330 is not only fixed on the light guide plate 220 and the supporting bar 240, but further fixed on the support piece 314A of the bottom frame 310. Furthermore, the surface of the support piece 314A may also be provided with an aligning line 314A1, and the edge of the flexible circuit board 332 may be aligned with the aligning line 314A1 to further enhance the accuracy of the position of the lighting bar 330.

To sum up, in the display device and the backlight module of the present application, since the lighting bar is attached to the light guide plate, the distance between the lighting elements on the lighting bar and the light incident side-surface of the light guide plate can be precisely controlled. In this way, the uniformity of the light source provided by backlight module can be ensured, and thereby to enhance the display quality of the display device.

It will be apparent to those skilled in the art that various modifications and variations can be made to the structure of the present application without departing from the scope or spirit of the application. In view of the foregoing, it is intended that the present application cover modifications and variations of this application provided they fall within the scope of the following claims and their equivalents.

What is claimed is:

1. A backlight module comprising:
a bottom frame comprising a bottom plate;
a light guide plate disposed on the bottom plate, and comprising a bottom surface, a light emitting surface, and a light incident side-surface, wherein the bottom surface is opposite to the light emitting surface, and the light incident side-surface is connected to the bottom surface and the light emitting surface;
a lighting bar comprising a flexible circuit board and a plurality of lighting elements, wherein the lighting elements are arranged in a row on a setting surface of the flexible circuit board, and the setting surface has a first region and a second region located at two sides of the row of lighting elements; and
a supporting bar comprising a bottom and a top opposite to the bottom, wherein the bottom is attached to the bottom plate, the top is attached to the first region of the setting surface, a portion of the light emitting surface adjacent to the light incident side-surface is attached to the second region of the setting surface, and the lighting elements are between the supporting bar and the light incident side-surface.

2. The backlight module according to claim 1, wherein a distance between the bottom and the top of the supporting bar is substantially equal to a thickness of the light guide plate.

3. The backlight module according to claim 1, wherein the top and the first region of the setting surface are attached to each other partially.

4. The backlight module according to claim 1, further comprises a reflector disposed between the light guide plate and the bottom plate.

5. The backlight module according to claim 4, wherein a distance between the bottom and the top of the supporting bar is substantially equal to a total thickness of the light guide plate and the reflector.

6. The backlight module according to claim 1, further comprising a plurality of optical films disposed at the light emitting surface of the light guide plate.

7. The backlight module according to claim 1, wherein the bottom frame further comprises a side plate connected to an edge of the bottom plate, the side plate is bent outward to form a support piece, and the support piece is attached to the first region of the setting surface.

8. The backlight module according to claim 7, further comprising a double-sided adhesive, wherein the support piece is attached to the first region of the setting surface through the double-sided adhesive.

9. The backlight module according to claim 7, wherein the surface of the support piece comprises an aligning line, the edge of the flexible circuit board is aligned with the aligning line.

10. The backlight module according to claim 1, further comprising a plastic frame disposed on the bottom plate, the plastic frame and the supporting bar surround the light guide plate together, and the plastic frame makes the light guide plate be attached on the bottom plate.

11. A display device, comprising:
a display panel;
a backlight module, wherein the display panel is disposed on the backlight module, and the backlight module comprising:
a bottom frame comprising a bottom plate;
a light guide plate disposed on the bottom plate, and comprising a bottom surface, a light emitting surface, and a light incident side-surface, wherein the bottom surface is opposite to the light emitting surface, the light incident side-surface is connected to the bottom surface and the light emitting surface, and the light guide plate is disposed between the bottom plate and the display panel;
a lighting bar comprising a flexible circuit board and a plurality of lighting elements, wherein the lighting elements are arranged in a row on a setting surface of the flexible circuit board, and the setting surface has a first region and a second region located at two sides of the row of lighting elements; and
a supporting bar, comprises a bottom and a top opposite to the bottom, wherein the bottom is attached to the bottom plate, the top is attached to the first region of the setting surface, a portion of the light emitting surface adjacent to the light incident side-surface is attached to the second region of the setting surface, and the lighting elements are between the supporting bar and the light incident side-surface.

12. The display device according to claim 11, wherein a distance between the bottom and the top of the supporting bar is substantially equal to a thickness of the light guide plate.

13. The display device according to claim 11, wherein the top and the first region of the setting surface are attached to each other partially.

14. The display device according to claim 11, wherein the backlight module further comprises a reflector disposed between the light guide plate and the bottom plate.

15. The display device according to claim 14, wherein a distance between the bottom and the top of the supporting bar is substantially equal to a total thickness of the light guide plate and the reflector.

16. The display device according to claim 11, wherein the bottom frame further comprises a side plate connected to an edge of the bottom plate, the side plate is bent outward to form a support piece, and the support piece is attached to the first region of the setting surface.

17. The display device according to claim 16, wherein the backlight module further comprises a double-sided adhesive, and the support piece is attached to the first region of the setting surface through the double-sided adhesive.

18. The display device according to claim 16, wherein the surface of the support piece comprises an aligning line, the edge of the flexible circuit board is aligned with the aligning line.

19. The display device according to claim 11, wherein the backlight module further comprises a plastic frame disposed on the bottom plate, the plastic frame and the supporting bar surround the light guide plate together, and the plastic frame makes the light guide plate be attached on the bottom plate.

20. The display device according to claim 11, further comprises a strip pad, disposed between the flexible circuit board and the display panel.
